(19) United States
(12) Patent Application Publication
(10) Pub. No.: US 2017/0061899 A1
(43) Pub. Date: Mar. 2, 2017

(54) IMAGE DISPLAY APPARATUS, IMAGE-PROCESSING APPARATUS, METHOD OF CONTROLLING IMAGE DISPLAY APPARATUS, AND METHOD OF CONTROLLING IMAGE-PROCESSING APPARATUS

(71) Applicant: CANON KABUSHIKI KAISHA, Tokyo (JP)

(72) Inventor: Yoshiyuki Nagashima, Kawasaki-shi (JP)

(21) Appl. No.: 15/244,339

(22) Filed: Aug. 23, 2016

(30) Foreign Application Priority Data
Aug. 26, 2015 (JP) 2015-166560

(51) Int. Cl. G09G 3/34; G09G 3/20; G09G 3/36

(52) U.S. Cl. CPC G09G 3/3406; G09G 3/36; G09G 3/2003; G09G 2320/066; G09G 2320/0666; G09G 2320/0233

(57) ABSTRACT

An image display apparatus includes: a display unit configured to display an image based on input image data on a screen; an acquiring unit configured to acquire dynamic range information regarding a dynamic range of brightness of the input image data; and a processing unit configured to perform, on the input image data, unevenness reduction processing of reducing unevenness in at least one of brightness and color, wherein the processing unit weakens a degree of reduction in unevenness by the unevenness reduction processing in an area where a brightness of the input image data is higher than a predetermined brightness, based on the dynamic range information.

### BACKGROUND OF THE INVENTION

Field of the Invention

The present invention relates to an image display apparatus, an image-processing apparatus, a method of controlling an image display apparatus, and a method of controlling an image-processing apparatus.

Description of the Related Art

In recent years, there has been a growing use of images having a wide dynamic range in image production workflows. Hereinafter, an image having a wide dynamic range is referred to as a “high-dynamic-range (HDR) image.” A data format of an HDR image is specified in the Academy Color Encoding System standard (ACES standard), for example.

Herein, it is assumed that the range of brightness of a non-HDR image can take is 0 to 100%. A non-HDR image is an image having a narrower dynamic range than an HDR image, and is an image in a data format specified in BT.709, for example. An HDR image can handle a brightness higher than 100%. A brightness higher than 100% is referred to as “super-white”, for example. In an area having a brightness within the range of 0 to 100%, it is preferable to reproduce a color accurately. On the other hand, in an area having a brightness higher than 100%, brightness (a sense of radiance) is more important than color (color reproducibility).

In an image production workflow using an HDR image, the HDR image is displayed in an image display apparatus, such as a liquid crystal display (LCD) apparatus, to check or edit the image. In an image production workflow, various images, such as an HDR image or a non-HDR image, are handled in accordance with the contents to be produced. Therefore, an HDR image, a non-HDR image, or both may be displayed in an image display apparatus.

In an image display apparatus, unevenness (display unevenness) in at least one of brightness and color occurs on a screen, in a case of displaying an image on the screen. For example, in a liquid crystal display apparatus, display unevenness due to characteristics of a liquid crystal panel, characteristics of a backlight unit, or the like occurs. Techniques of reducing the display unevenness are disclosed in, for example, Japanese Patent Application Laid-open No. 2007-114427 and Japanese Patent Application Laid-open No. 2008-310261. Japanese Patent Application Laid-open No. 2007-114427 discloses a technique of reducing the brightness in a middle portion of a screen to a brightness equivalent to the brightness in an edge portion of the screen, as a technique of reducing display unevenness (brightness unevenness) in which the brightness in the edge portion of the screen is lower than the brightness in the middle portion of the screen. Japanese Patent Application Laid-open No. 2008-310261 discloses a technique of weakening the degree of reduction in display unevenness more greatly in a case where the intensity of a color component of image data is higher.

However, with the technique disclosed in Japanese Patent Application Laid-open No. 2007-114427, the display brightness (brightness on the screen) of super-white in a case of displaying an HDR image may decrease, since the brightness in the middle portion of the screen is reduced. As described above, brightness is more important than color in an area having a brightness of super-white. Therefore, a decrease in display brightness of super-white is not preferable.

With the technique disclosed in Japanese Patent Application Laid-open No. 2008-310261, the degree of reduction in display unevenness may be weakened in an area having a high gradation value (high-gradation area) in a case of displaying a non-HDR image, since the degree of reduction in display unevenness is weakened more greatly in a case where the intensity of a color component of image data is higher. The brightness of the high-gradation area is a brightness within the range of 0 to 100%. As described above, it is preferable to reproduce the color accurately in an area having a brightness within the range of 0 to 100%. Therefore, weakening the degree of reduction in display unevenness in the high-gradation area is not preferable.

### SUMMARY OF THE INVENTION

The present invention provides a technique that can suitably suppress a decrease in display brightness and that can suitably reduce display unevenness.

The present invention in its first aspect provides an image display apparatus comprising:

a display unit configured to display an image based on input image data on a screen;

an acquiring unit configured to acquire dynamic range information regarding a dynamic range of brightness of the input image data; and

a processing unit configured to perform, on the input image data, unevenness reduction processing of reducing unevenness in at least one of brightness and color, wherein

the processing unit weakens a degree of reduction in unevenness by the unevenness reduction processing in an area where a brightness of the input image data is higher than a predetermined brightness, based on the dynamic range information.

The present invention in its second aspect provides an image-processing apparatus comprising:

an acquiring unit configured to acquire dynamic range information regarding a dynamic range of brightness of input image data; and

a processing unit configured to perform, on the input image data, unevenness reduction processing of reducing unevenness in at least one of brightness and color, wherein

the processing unit weakens a degree of reduction in unevenness by the unevenness reduction processing in an area where a brightness corresponding to a gradation value of the input image data is higher than a predetermined brightness, based on the dynamic range information.

The present invention in its third aspect provides a method of controlling an image display apparatus including a display unit configured to display an image based on input image data on a screen,

the method comprising:

an acquiring step of acquiring dynamic range information regarding a dynamic range of brightness of the input image data; and

a processing step of performing, on the input image data, unevenness reduction processing of reducing unevenness in at least one of brightness and color, wherein

in the processing step, a degree of reduction in unevenness by the unevenness reduction processing is weakened in an area where a brightness of the input image data is higher than a predetermined brightness, based on the dynamic range information.

The present invention in its fourth aspect provides a method of controlling an image-processing apparatus comprising:

an acquiring step of acquiring dynamic range information regarding a dynamic range of brightness of input image data; and

a processing step of performing, on the input image data, unevenness reduction processing of reducing unevenness in at least one of brightness and color, wherein

in the processing step, a degree of reduction in unevenness by the unevenness reduction processing is weakened in an area where a brightness corresponding to a gradation value of the input image data is higher than a predetermined brightness, based on the dynamic range information.

The present invention in its fifth aspect provides a non-transitory computer readable medium that stores a program, wherein

the program causes a computer to execute a method of controlling an image display apparatus including a display unit configured to display an image based on input image data on a screen,

the method includes:
an acquiring step of acquiring dynamic range information regarding a dynamic range of brightness of the input image data; and
a processing step of performing, on the input image data, unevenness reduction processing of reducing unevenness in at least one of brightness and color, and

in the processing step, a degree of reduction in unevenness by the unevenness reduction processing is weakened in an area where a brightness of the input image data is higher than a predetermined brightness, based on the dynamic range information.

The present invention in its sixth aspect provides a non-transitory computer readable medium that stores a program, wherein

the program causes a computer to execute a method of controlling an image-processing apparatus,

the method includes:
an acquiring step of acquiring dynamic range information regarding a dynamic range of brightness of input image data; and
a processing step of performing, on the input image data, unevenness reduction processing of reducing unevenness in at least one of brightness and color, and

in the processing step, a degree of reduction in unevenness by the unevenness reduction processing is weakened in an area where a brightness corresponding to a gradation value of the input image data is higher than a predetermined brightness, based on the dynamic range information.

With the present invention, a decrease in display brightness can suitably be suppressed, and display unevenness can suitably be reduced.

Further features of the present invention will become apparent from the following description of exemplary embodiments with reference to the attached drawings.

### BRIEF DESCRIPTION OF THE DRAWINGS

FIG. 1 is a block diagram showing an example of the functional configuration of an image display apparatus according to Embodiment 1;

FIG. 2 is a diagram for illustrating an example of an unevenness correction parameter according to Embodiment 1;

FIG. 3 is a diagram for illustrating an example of the unevenness correction parameter according to Embodiment 1;

FIG. 4 is a block diagram showing an example of the functional configuration of an image display apparatus according to Embodiment 2;

FIG. 5 is a block diagram showing an example of the functional configuration of an image display apparatus according to Embodiment 3;

FIG. 6 is a diagram showing an example of a statistic obtained by a statistic acquisition unit according to Embodiment 3; and

FIG. 7 is a diagram for illustrating an example of an unevenness correction parameter according to Embodiment 3.

### DESCRIPTION OF THE EMBODIMENTS

### Embodiment 1

An image display apparatus, an image-processing apparatus, and a method of controlling the same according to Embodiment 1 of the present invention will be described below. An image display apparatus according to this embodiment is an image display apparatus including an image-processing apparatus according to this embodiment. The image-processing apparatus according to this embodiment may be an apparatus separate from the image display apparatus.

In this embodiment, an image having a wide dynamic range is referred to as an “HDR image,” and an image having a narrower dynamic range than an HDR image is referred to as a “non-HDR image.” An HDR image is, for example, an image in a data format specified in the Academy Color Encoding System standard (ACES standard). A non-HDR image is, for example, an image in a data format specified in BT.709. In this embodiment, it is assumed that the range of brightness of a non-HDR image can take is 0 to 100. An HDR image can handle a brightness higher than 100%. A brightness higher than 100% is referred to as “super-white”, for example.

In an image display apparatus, unevenness (display unevenness) in at least one of brightness and color occurs on a screen in a case of displaying an image on the screen. Thus, in an image display apparatus according to this embodiment, unevenness reduction processing of reducing the display unevenness that occurs on a screen in a case of displaying an image based on input image data on the screen is performed on the input image data. The image display apparatus according to this embodiment performs the unevenness reduction processing of reducing the display unevenness sufficiently in a non-super-white area within the screen. The non-super-white area is an area where color is reproduced accurately, and is an area where the brightness corresponding to the gradation value of input image data is less than or equal to a predetermined brightness (100%). The image display apparatus according to this embodiment weakens the unevenness reduction degree (degree of reduction in display unevenness by the unevenness reduction processing) in a super-white area within the screen. The super-white area is an area where brightness (a sense of radiance) is more important than color (color reproducibility), and is an area where the brightness corresponding to the gradation value of input image data is higher than the predetermined brightness (100%).

Accordingly, in a case of displaying an HDR image, a non-HDR image, or both, a decrease in display brightness (brightness on the screen) can suitably be suppressed, and display unevenness can suitably be reduced. Specifically, in the entire area of a non-HDR image and a non-super-white area of an HDR image, display in which color is reproduced accurately can be performed by sufficiently reducing the display unevenness. In a super-white area of an HDR image, a decrease in display brightness can be suppressed, and display with a sufficient sense of radiance can be performed, by weakening the unevenness reduction degree.

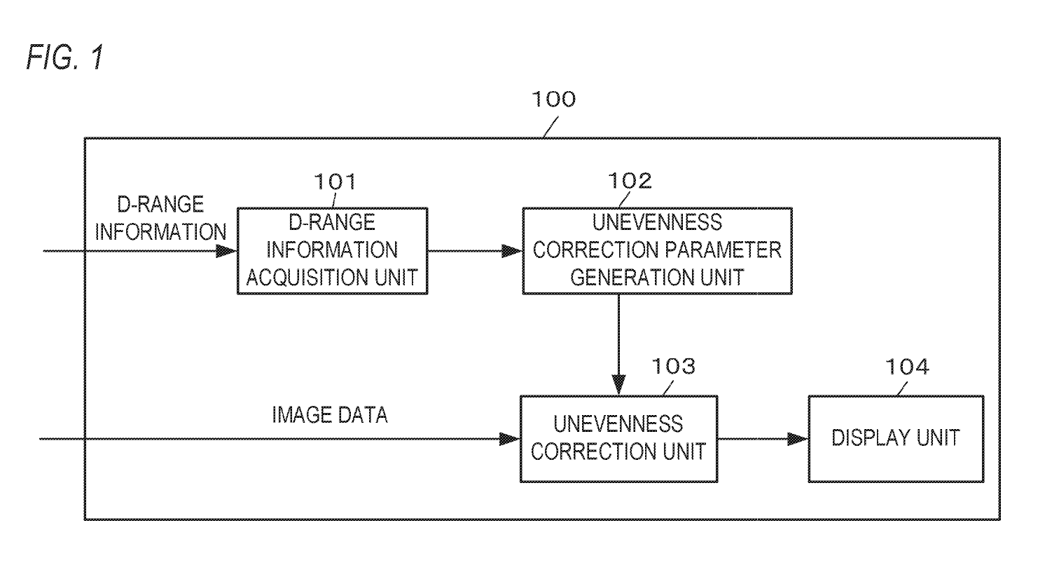

FIG. 1 is a block diagram showing an example of the functional configuration of an image display apparatus 100 according to this embodiment. The image display apparatus 100 includes a D-range information acquisition unit 101, an unevenness correction parameter generation unit 102, an unevenness correction unit 103, and a display unit 104. The display unit 104 may be provided to an apparatus separate from the image display apparatus 100. In that case, the image display apparatus 100 could rather be called an “image-processing apparatus 100.”

The D-range information acquisition unit 101 acquires D-range information (dynamic range information) that is information regarding the dynamic range (D-range) of brightness of input image data.

A method of acquiring the D-range information is not particularly limited. In the case where the D-range information is added to input image data (image data that has been input to the image display apparatus 100), the D-range information acquisition unit 101 can acquire the D-range information from the input image data. In the case where image data for the serial digital interface (SDI) standard is input to the image display apparatus 100 as the input image data, ancillary data describing the D-range information may be input to the image display apparatus 100. In that case, the D-range information acquisition unit 101 can acquire the D-range information from the ancillary data. In the case where the D-range information cannot be acquired from ancillary data, the D-range information acquisition unit 101 may generate the D-range information in accordance with the current setting regarding display with the image display apparatus 100 (display unit 104). For example, in the case where the current setting is set in BT.709, it may be such that the dynamic range of brightness of input image data is determined as 0 to 100%, and D-range information regarding a D-range of 0 to 100% is generated. In the case where the current setting is set to ACES, it may be such that the dynamic range of brightness of input image data is determined as a range in ACES, and D-range information regarding a D-range (e.g., 0 to 800%) specified in ACES is generated. The setting regarding display is, for example, a setting of an image quality parameter such as the gamut, gamma value, or the like of a display image.

As the D-range information, one piece of D-range information corresponding to the entire area of the screen may be acquired, or a plurality of pieces of D-range information corresponding to a plurality of areas within the screen may be acquired. For example, in the case where a plurality of images are arranged and displayed on the screen, the D-range information may be acquired for each of the plurality of images.

Based on the D-range information acquired by the D-range information acquisition unit 101, the unevenness correction parameter generation unit 102 determines the correspondence relationship of the gradation value (input gradation value) of input image data and the brightness (brightness level). For example, a correspondence relationship in which the upper limit value of input gradation value corresponds to the upper limit value of brightness of a D-range corresponding to the D-range information and in which the lower limit value of input gradation value corresponds to the lower limit value of brightness of the D-range corresponding to the D-range information is obtained as the correspondence relationship. Based on the obtained correspondence relationship, the unevenness correction parameter generation unit 102 generates (determines) an unevenness correction parameter. The unevenness correction parameter is a parameter used in the unevenness reduction processing. In the case where a plurality of pieces of the D-range information corresponding to a plurality of areas within the screen are acquired, determination on the correspondence relationship and generation of the unevenness correction parameter are performed for each of the plurality of areas.

In this manner, in this embodiment, the brightness corresponding to the input gradation value is determined using the D-range information. By using the D-range information, the brightness corresponding to the input gradation value can be determined with higher precision than by a method of determining the brightness only from the input gradation value. For example, 8-bit gradation values may be used as both the input gradation value for an HDR image and the input gradation value for a non-HDR image. In this case, the brightness corresponding to the input gradation value cannot be determined accurately only from the input gradation value. For example, a brightness for a non-HDR image may be erroneously determined as a brightness corresponding to an input gradation value, regardless of the input gradation value being a gradation value for an HDR image. In this embodiment, such an erroneous determination does not occur, since the D-range information is used.

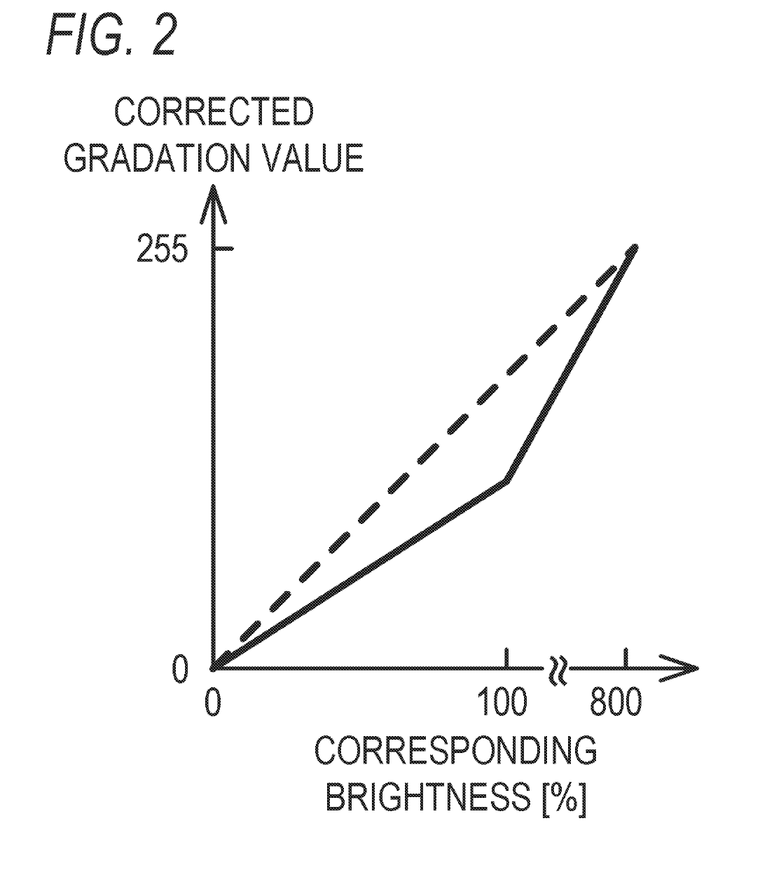

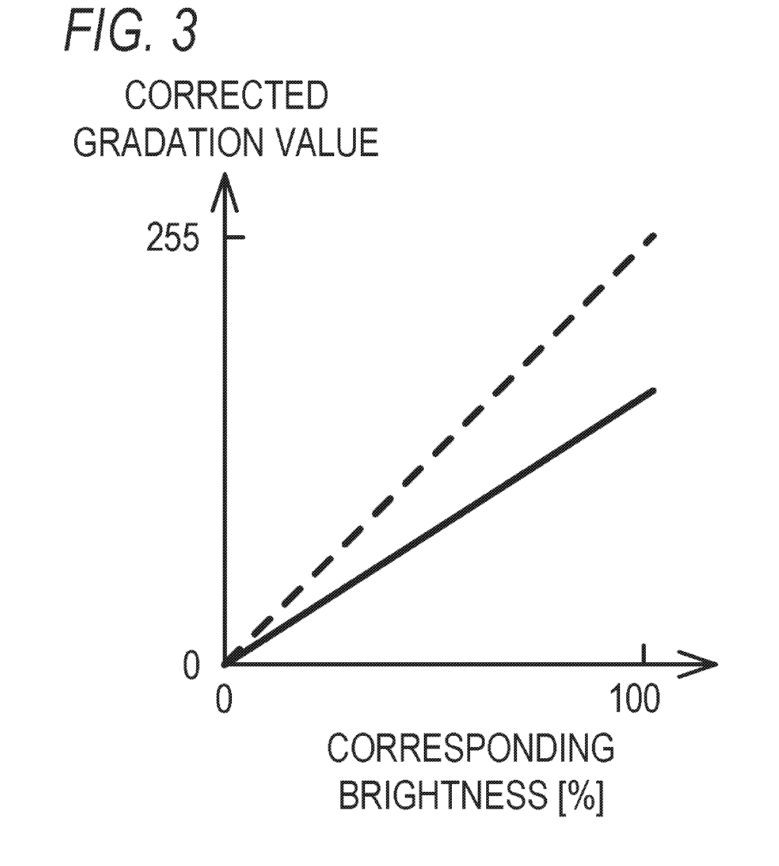

In this embodiment, the unevenness reduction processing of reducing the display unevenness sufficiently is performed in a non-super-white area, and the unevenness correction parameter is generated such that the unevenness reduction degree is weakened in a super-white area. An example of the unevenness correction parameter will be described using FIGS. 2 and 3. FIGS. 2 and 3 show an example of a case where display unevenness (brightness unevenness) in which the brightness in an edge portion of the screen is lower than the brightness in a middle portion of the screen occurs, in a case where an image (solid image) based on image data with a uniform gradation value is displayed on the screen. FIGS. 2 and 3 show an example of a case where unevenness reduction processing is performed such that the brightness of the solid image in an area other than the edge portion is reduced to a brightness equivalent to the brightness of the solid image in the edge portion. The abscissa in FIGS. 2 and 3 show the brightness (corresponding brightness) corresponding to the input gradation value, and the ordinate in FIGS. 2 and 3 show the corrected gradation value (gradation value after the unevenness reduction processing) corresponding to the middle portion of the screen. The broken line shows a case where the unevenness reduction processing is not performed. Therefore, the corrected gradation value shown by the broken line is equivalent to the input gradation value.

FIG. 2 shows an example of a case where information regarding the dynamic range of an HDR image is obtained as the D-range information, and FIG. 3 shows an example of a case where information regarding the dynamic range of a non-HDR image is obtained as the D-range information. Specifically, FIG. 2 shows an example of a case where information regarding a dynamic range of 0 to 800% is obtained as the D-range information, and FIG. 3 shows an example of a case where information regarding a dynamic range of 0 to 100% is obtained as the D-range information. FIGS. 2 and 3 show examples of a case where an 8-bit value (0 to 255) is obtained as the corrected gradation value. The dynamic range of an HDR image may be wider than or narrower than 0 to 800%. The number of bits of the corrected gradation value may be more than or less than 8. The number of bits of the input gradation value is also not particularly limited.

In this embodiment, regarding the brightness unevenness, it is assumed that the difference of the brightness in the edge portion of the screen and the brightness in the middle portion of the screen increases as the corresponding brightness increases. Therefore, the unevenness correction parameter is generated such that, in a range of 0 to 100% in corresponding brightness, the input gradation value is reduced, and the amount of reduction in input gradation value increases as the corresponding brightness increases (see solid lines in FIGS. 2 and 3). As a result, display unevenness can be reduced sufficiently in the range of 0 to 100% in corresponding brightness.

In this embodiment, the unevenness correction parameter is generated such that, in a range higher than 100% in corresponding brightness, reduction of the input gradation value is suppressed (see solid line in FIG. 2). Herein, “suppression of reduction in input gradation value” indicates “reduction in unevenness reduction degree.” For the range higher than 100% in corresponding brightness in FIG. 2, the input gradation value is reduced, and the amount of reduction in input gradation value is reduced as the corresponding brightness increases. Accordingly, in a super-white area, the unevenness reduction degree is weakened to a lower value in a case where the corresponding brightness is higher. In a super-white area, a sense of radiance is given greater importance in a case where the brightness is higher. Therefore, by weakening the unevenness reduction degree to a lower value in a case where the corresponding brightness is higher in a super-white area, display unevenness can more suitably be reduced, and a decrease in display brightness can more suitably be suppressed.

Regarding the brightness unevenness, the difference in brightness from the edge portion depends on the position within the screen. Therefore, the correspondence relationship (solid line in FIGS. 2 and 3) of the corresponding brightness and the corrected gradation value also depends on the position within the screen. While an example in which the corresponding brightness increases linearly as the input gradation value increases has been described in this embodiment for the sake of a simple illustration, this is not limiting. For example, the corresponding brightness may increase non-linearly with respect to an increase in input gradation value. The correspondence relationship of the corrected gradation value and the corresponding brightness is also not particularly limited. The corrected gradation value may change continuously with respect to a change in corresponding brightness, or the corrected gradation value may change discontinuously with respect to a change in corresponding brightness. The unevenness reduction degree in a super-white area is also not particularly limited. For example, the unevenness correction parameter may be generated such that the unevenness reduction degree not dependent on the corresponding brightness is set in a super-white area. Display unevenness is also not particularly limited, and a method of the unevenness reduction processing is also not particularly limited. The display unevenness depends on the characteristics of the display unit 104, and the correspondence relationship (solid line in FIGS. 2 and 3) of the corresponding brightness and the corrected gradation value is changed appropriately in accordance with the characteristics of the display unit 104.

The unevenness correction unit 103 performs the unevenness reduction processing on input image data, based on a result of determination by the unevenness correction parameter generation unit 102. Specifically, the unevenness correction unit 103 performs, on input image data, the unevenness reduction processing using the unevenness correction parameter generated by the unevenness correction parameter generation unit 102. Accordingly, corrected image data is generated. By the unevenness correction parameter generated by the unevenness correction parameter generation unit 102 being used, the unevenness reduction processing of reducing the display unevenness sufficiently is performed in a non-super-white area. In a super-white area, the unevenness reduction processing in which the unevenness reduction degree is weakened is performed.

In the case where a plurality of the unevenness correction parameters corresponding to a plurality of areas within the screen have been obtained, the unevenness reduction processing is performed for each of the plurality of areas, using at least the unevenness correction parameter corresponding to the area.

While an example in which the unevenness correction parameter is determined and used based on the D-range information has been described in this embodiment, this is not limiting. For example, information showing the correspondence relationship (correspondence relationship of the input gradation value and the brightness) obtained based on the D-range information may be used instead of the unevenness correction parameter. Using such information enables a super-white area and a non-super-white area to be detected, and thus enables the unevenness reduction processing described above to be performed.

The display unit 104 displays an image based on corrected image data on the screen. For the display unit 104, a liquid crystal display panel, an organic EL display panel, a plasma display panel, or the like can be used. Each display element of the display unit 104 may be driven in accordance with corrected image data, or it may be otherwise. For example, it may be such that alternative image processing different from the unevenness reduction processing is performed on corrected image data by the display unit 104, and each display element of the display unit 104 is driven in accordance with image data after the alternative image processing. As the alternative image processing, brightness adjustment processing, color adjustment processing, edge enhancement processing, blurring processing, or the like is performed, for example.

As described above, in this embodiment, the correspondence relationship of the input gradation value and the brightness is determined using the D-range information. Accordingly, the brightness corresponding to the input gradation value can be determined with high precision. In this embodiment, the unevenness reduction degree is weakened in a super-white area. Accordingly, in a case of displaying an HDR image, a non-HDR image, or both, a decrease in display brightness can suitably be suppressed, and display unevenness can suitably be reduced. By suitably suppressing a decrease in display brightness, a decrease in contrast ration of a display image (image displayed on the screen) can also suitably be suppressed.

While an example of a case where the range of gradation value of input image data is constant (a range corresponding to 8 bits) has been described in this embodiment, this is not limiting. In the case where the range of gradation value of input image data is not constant, the image display apparatus or the image-processing apparatus may include a conversion unit that converts the gradation value of input image data to a gradation value of a predetermined range. It can be said that processing of converting the gradation value of input image data to a gradation value of a predetermined range is “normalization.” In that case, the correspondence relationship of the gradation value after normalization of input image data and the brightness of input image data may be determined based on the dynamic range information. The unevenness reduction processing may be performed on image data after normalization. The predetermined range is, for example, a range corresponding to the number of bits of the display unit 104, a range corresponding to the number of bits of a processing unit of the unevenness correction unit 103, or the like. Herein, it is assumed that the range of gradation value of input image data is a 12-bit range (0 to 4095), the dynamic range of brightness of input image data is 0 to 100%, and the predetermined range is an 8-bit range (0 to 255). In this case, a gradation value of 0 that is the lower limit value of gradation value after normalization may be associated with a brightness of 0% in the correspondence relationship. A gradation value of 255 that is the upper limit value of gradation value after normalization, instead of a gradation value of 4095 that is the upper limit value of gradation value before normalization, may be associated with a brightness of 100%.

### Embodiment 2

An image display apparatus and a method of controlling the same according to Embodiment 2 of the present invention will be described below. In Embodiment 1, a change (decrease) in display brightness due to unevenness reduction processing occurs. Specifically, unevenness reduction processing of reducing the display unevenness sufficiently is performed in a non-super-white area, and therefore the display brightness decreases. In this embodiment, an example in which a change (decrease) in display brightness due to the unevenness reduction processing can be reduced will be described.

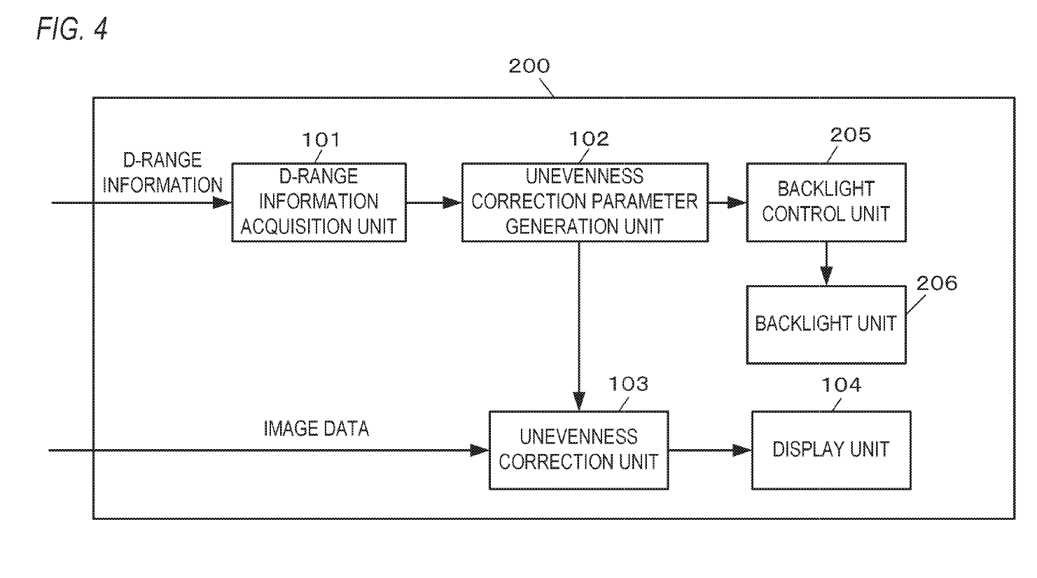

FIG. 4 is a block diagram showing an example of the functional configuration of an image display apparatus 200 according to this embodiment. As shown in FIG. 4, the image display apparatus 200 further includes a backlight control unit 205 and a backlight unit 206, in addition to functional units included in the image display apparatus 100 of Embodiment 1 (FIG. 1). In FIG. 4, the same functional units as in Embodiment 1 (FIG. 1) are denoted by the same reference numerals as in Embodiment 1. Description thereof is omitted.

The backlight unit 206 is a light-emitting unit that illuminates the back surface of the display unit 104. As a light-emitting element of the backlight unit 206, a light-emitting diode (LED), an organic EL element, a cold-cathode tube, or the like can be used. In this embodiment, the display unit 104 displays an image based on image data on a screen, by modulating (transmitting or reflecting) of light from the backlight unit 206 based on the image data. Specifically, a transmissive liquid crystal panel that transmits light from the backlight unit 206 based on image data is used as the display unit 104. The display unit 104 is not limited to the transmissive liquid crystal panel. For example, a reflective liquid crystal panel that reflects light from the backlight unit 206 based on image data may be used as the display unit 104. A micro-electro-mechanical-system (MEMS) shutter display panel using a MEMS shutter, instead of a liquid crystal element, may be used as the display unit 104.

The backlight control unit 205 controls the brightness of light emitted by the backlight unit 206, such that a change in display brightness due to the unevenness reduction processing is reduced. For example, in the case where the display brightness is reduced by 10% by the unevenness reduction processing, the brightness of light emitted by the backlight unit 206 is increased by 10%. In this embodiment, the backlight control unit 205 controls the brightness of light emitted by the backlight unit 206, based on an unevenness correction parameter generated by the unevenness correction parameter generation unit 102. For example, the backlight control unit 205 calculates the difference of the input gradation value and the corrected gradation value for each of a plurality of corresponding brightnesses, using the unevenness correction parameter. The backlight control unit 205 controls the brightness of light emitted by the backlight unit 206, based on a plurality of the calculated differences. For example, the backlight control unit 205 controls the brightness of light emitted by the backlight unit 206, using a representative value (the maximum value, the median value, the average value, or the like) of the plurality of differences as a value corresponding to the amount of change in display brightness due to the unevenness reduction processing.

A method of controlling the brightness of light emitted by the backlight unit 206 is not particularly limited, as long as a change in display brightness due to the unevenness reduction processing is reduced. For example, the difference of the input gradation value and the corrected gradation value may be calculated for each of a plurality of pixels of input image data. The brightness of light emitted by the backlight unit 206 may be controlled based on the plurality of calculated differences. For example, the brightness of light emitted by the backlight unit 206 may be controlled, using a representative value (the maximum value, the median value, the average value, or the like) of the plurality of differences as a value corresponding to the amount of change in display brightness due to the unevenness reduction processing. The difference of the input gradation value and the corrected gradation value for each pixel of input image data can be obtained from the input image data and a result of determination by the unevenness correction parameter generation unit 102. The brightness of light emitted by the backlight unit 206 may be controlled in accordance with a D-range corresponding to D-range information. The brightness of light emitted by the backlight unit 206 may be controlled, such the display brightness changes in accordance with the D-range corresponding to the D-range information.

As described above, in this embodiment, the brightness of light emitted by the backlight unit is controlled, such that a change in display brightness due to the unevenness reduction processing is reduced. Accordingly, a decrease in display brightness can be suppressed in both a super-white area and a non-super-white area.

### Embodiment 3

An image display apparatus, an image-processing apparatus, and a method of controlling the same according to Embodiment 3 of the present invention will be described below. In this embodiment, an example will be described in which the unevenness reduction degree is controlled, such that a decrease in display brightness can more suitably be suppressed, and display unevenness can more suitably be reduced. While a case where a configuration characteristic to this embodiment (configuration of controlling the unevenness reduction degree) is combined with the configuration of Embodiment 2 is described below, the configuration characteristic to this embodiment can also be combined with the configuration of Embodiment 1.

Display unevenness in a super-white area is more noticeable in a case where the size of the super-white area is greater. Therefore, in the case where the size of the super-white area is large, reducing the display unevenness is more important than suppressing a decrease in display brightness. On the other hand, display unevenness in a super-white area is less noticeable in a case where the size of the super-white area is smaller. Therefore, in the case where the size of the super-white area is small, suppressing a decrease in display brightness is more important than reducing the display unevenness.

Thus, in a super-white area, in this embodiment, the unevenness reduction degree is weakened to a lower value in a case where the size of the super-white area is smaller. Accordingly, a decrease in display brightness can more suitably be suppressed, and display unevenness can more suitably be reduced. Specifically, display unevenness in the super-white area can be reduced sufficiently in the case where the size of the super-white area is large, and a decrease in display brightness in the super-white area can be suppressed sufficiently in the case where the size of the super-white area is small.

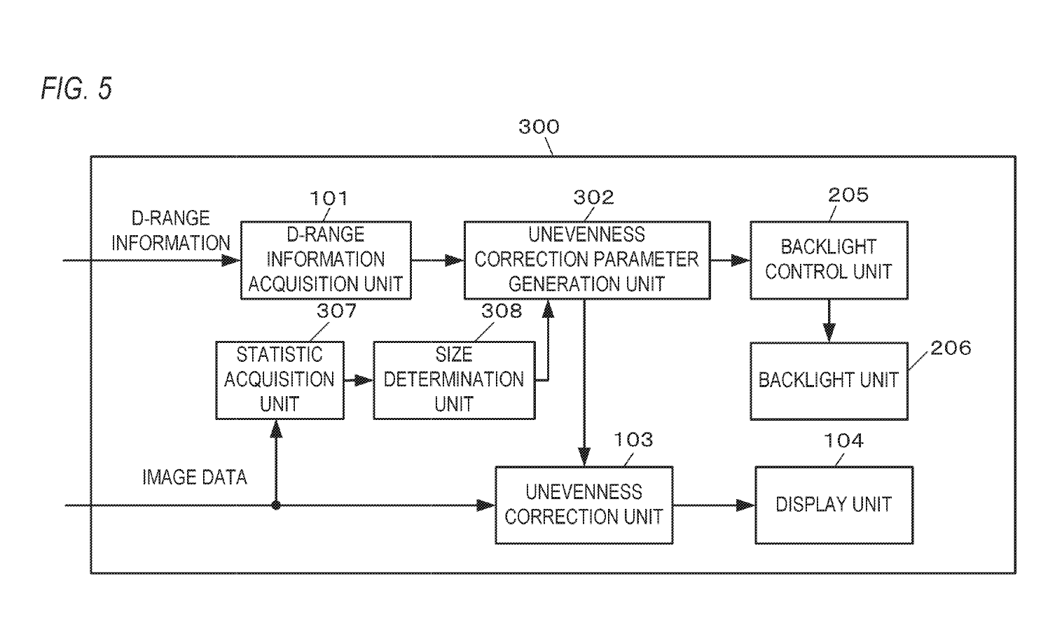

FIG. 5 is a block diagram showing an example of the functional configuration of an image display apparatus 300 according to this embodiment. As shown in FIG. 5, the image display apparatus 300 further includes a statistic acquisition unit 307 and a size determination unit 308, in addition to functional units included in the image display apparatus 200 of Embodiment 2 (FIG. 4). In FIG. 5, the same functional units as in Embodiment 2 (FIG. 4) are denoted by the same reference numerals as in Embodiment 2. Description thereof is omitted.

The statistic acquisition unit 307 acquires a statistic of input gradation value from input image data. As the statistic, a histogram of gradation value is acquired, for example. The image display apparatus 300 may not include the statistic acquisition unit 307.

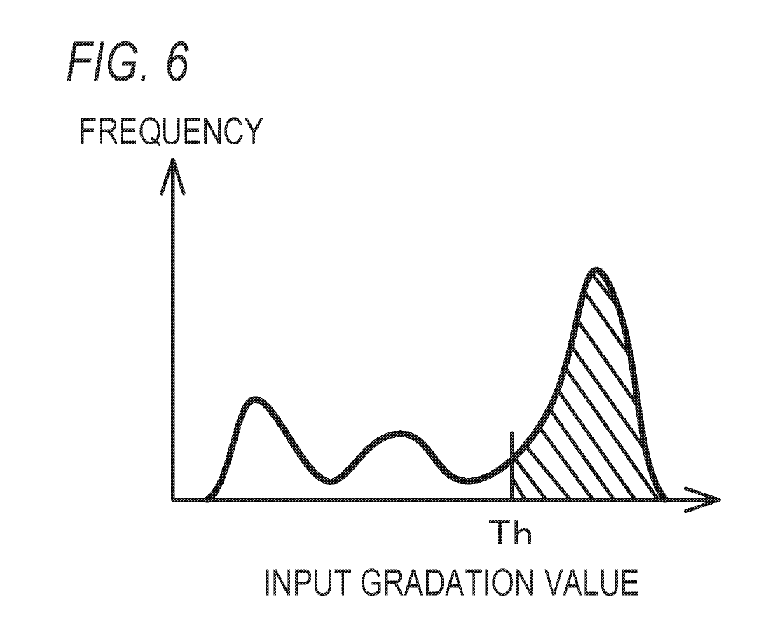

The size determination unit 308 determines the size of a super-white area, based on the D-range information acquired by the D-range information acquisition unit 101. Specifically, the size determination unit 308 determines the size of a super-white area, based on input image data and the correspondence relationship (correspondence relationship of the input gradation value and the corresponding brightness) obtained by an unevenness correction parameter generation unit 302. In this embodiment, a super-white size (size of a super-white area) is determined, based on the statistic obtained by the statistic acquisition unit 307 and the correspondence relationship obtained by the unevenness correction parameter generation unit 302. FIG. 6 shows an example of the statistic (histogram of gradation value) obtained by the statistic acquisition unit 307. In this embodiment, the size of a shaded area shown in FIG. 6 is determined as the super-white size. The size of the shaded area is the sum of frequencies in a range in which the gradation value is greater than a predetermined gradation value Th. The predetermined gradation value Th is an input gradation value corresponding to a brightness of 100%.

The unevenness correction parameter generation unit 302 determines the correspondence relationship of the input gradation value and the corresponding brightness by a method similar to that for the unevenness correction parameter generation unit 102 of Embodiment 1. The unevenness correction parameter generation unit 302 generates an unevenness correction parameter, based on the correspondence relationship of the input gradation value and the corresponding brightness and the super-white size determined by the size determination unit 308. In this embodiment as well, in a similar manner to Embodiment 1, unevenness reduction processing of reducing the display unevenness sufficiently is performed in a non-super-white area, and the unevenness correction parameter is generated such that the unevenness reduction degree is weakened in a super-white area. Note that, in a super-white area in this embodiment, the unevenness correction parameter is generated such that the unevenness reduction degree is weakened to a lower value in a case where the size of the super-white area is smaller.

A method of generating the unevenness correction parameter is not particularly limited. For example, it may be such that the unevenness correction parameter is generated by a method similar to that in Embodiment 1, and then, for a super-white area, the unevenness correction parameter is corrected such that the unevenness reduction degree is weakened to a lower value in a case where the size of the super-white area is smaller. The unevenness correction parameter may be generated in consideration of the super-white size from the beginning.

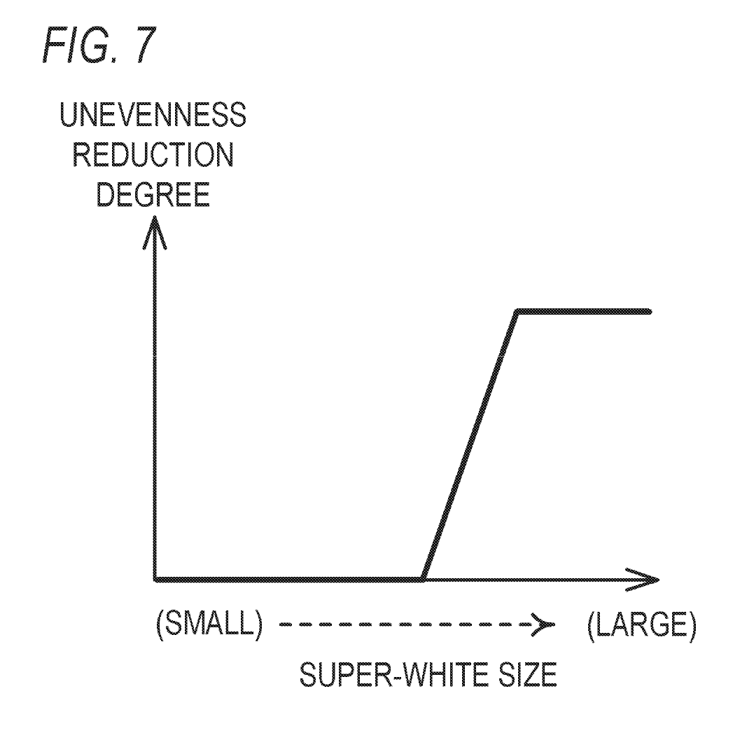

An example of the correspondence relationship of the super-white size and the unevenness reduction degree in a super-white area is shown in FIG. 7. The abscissa in FIG. 7 shows the super-white size, and the ordinate in FIG. 7 shows the unevenness reduction degree in a super-white area. From FIG. 7, it can be seen that a greater value is used as the unevenness reduction degree in a case where the super-white size is greater.

With this embodiment, as described above, the unevenness reduction degree in a super-white area is weakened to a lower value in a case where the size of the super-white area is smaller. Accordingly, a decrease in display brightness can more suitably be suppressed, and display unevenness can more suitably be reduced.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment (s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-166560, filed on Aug. 26, 2015, which is hereby incorporated by reference herein in its entirety.

What is claimed is:

1. An image display apparatus comprising:
a display unit configured to display an image based on input image data on a screen;
an acquiring unit configured to acquire dynamic range information regarding a dynamic range of brightness of the input image data; and
a processing unit configured to perform, on the input image data, unevenness reduction processing of reducing unevenness in at least one of brightness and color, wherein
the processing unit weakens a degree of reduction in unevenness by the unevenness reduction processing in an area where a brightness of the input image data is higher than a predetermined brightness, based on the dynamic range information.

2. The image display apparatus according to claim 1, wherein the processing unit weakens the degree of reduction in unevenness by the unevenness reduction processing to a lower value in a case where the brightness of the input image data is higher, in the area where the brightness of the input image data is higher than the predetermined brightness.

3. The image display apparatus according to claim 1,
wherein the processing unit includes
a determining unit configured to determine a correspondence relationship of a gradation value of the input image data and the brightness of the input image data, based on the dynamic range information, and
an unevenness correcting unit configured to perform the unevenness reduction processing on the input image data, and
wherein the unevenness correcting unit weakens the degree of reduction in unevenness by the unevenness reduction processing in the area where the brightness of the input image data is higher than the predetermined brightness, based on a result of determination by the determining unit.

4. The image display apparatus according to claim 3, wherein the determining unit determines a correspondence relationship of a gradation value in a predetermined range corresponding to the gradation value of the input image data and the brightness of the input image data, based on the dynamic range information.

5. The image display apparatus according to claim 3, wherein the determining unit determines a parameter used in the unevenness reduction processing based on the correspondence relationship, such that the degree of reduction in unevenness by the unevenness reduction processing is weakened in the area where the brightness of the input image data is higher than the predetermined brightness.

6. The image display apparatus according to claim 1, wherein the acquiring unit generates the dynamic range information in accordance with a setting regarding display by the display unit.

7. The image display apparatus according to claim 1, further comprising:
a light-emitting unit; and
a control unit configured to control a brightness of light emitted by the light-emitting unit,
wherein the display unit modulates light from the light-emitting unit based on image data to display an image based on the image data on the screen, and
wherein the control unit controls the brightness of light emitted by the light-emitting unit such that a change in brightness of the screen due to the unevenness reduction processing is reduced.

8. The image display apparatus according to claim 1, wherein, in the area where the brightness of the input image data is higher than the predetermined brightness, the processing unit weakens the degree of reduction in unevenness by the unevenness reduction processing to a lower value in a case where a size of the area is smaller.

9. The image display apparatus according to claim 8, further comprising a size determining unit configured to determine the size of the area where the brightness of the input image data is higher than the predetermined brightness, based on the dynamic range information.

10. An image-processing apparatus comprising:
an acquiring unit configured to acquire dynamic range information regarding a dynamic range of brightness of input image data; and
a processing unit configured to perform, on the input image data, unevenness reduction processing of reducing unevenness in at least one of brightness and color, wherein
the processing unit weakens a degree of reduction in unevenness by the unevenness reduction processing in an area where a brightness corresponding to a gradation value of the input image data is higher than a predetermined brightness, based on the dynamic range information.

11. A method of controlling an image display apparatus including a display unit configured to display an image based on input image data on a screen,
the method comprising:
an acquiring step of acquiring dynamic range information regarding a dynamic range of brightness of the input image data; and
a processing step of performing, on the input image data, unevenness reduction processing of reducing unevenness in at least one of brightness and color, wherein
in the processing step, a degree of reduction in unevenness by the unevenness reduction processing is weakened in an area where a brightness of the input image data is higher than a predetermined brightness, based on the dynamic range information.

12. A method of controlling an image-processing apparatus comprising:
an acquiring step of acquiring dynamic range information regarding a dynamic range of brightness of input image data; and
a processing step of performing, on the input image data, unevenness reduction processing of reducing unevenness in at least one of brightness and color, wherein
in the processing step, a degree of reduction in unevenness by the unevenness reduction processing is weakened in an area where a brightness corresponding to a gradation value of the input image data is higher than a predetermined brightness, based on the dynamic range information.
